(19) United States
(12) Patent Application Publication
(10) Pub. No.: US 2018/0048813 A1
(43) Pub. Date: Feb. 15, 2018

(54) IMAGE CAPTURING SYSTEM AND IMAGE CAPTURING METHOD

(71) Applicants: Inventec (Pudong) Technology Corporation, Shanghai (CN); INVENTEC CORPORATION, Taipei City (TW)

(72) Inventors: Kao-Sheng SU, TAIPEI CITY (TW); Lung-Hsun SONG, TAIPEI CITY (TW); Kuan-Hung CHEN, TAIPEI CITY (TW); Kang-Yu HSU, TAIPEI CITY (TW)

(21) Appl. No.: 15/331,906

(22) Filed: Oct. 23, 2016

(30) Foreign Application Priority Data
Aug. 9, 2016 (CN) 201610644778.5

(51) Int. Cl. H04N 5/232; H04N 5/247

(52) U.S. Cl. CPC H04N 5/23238; H04N 5/23203; H04N 5/247

(57) ABSTRACT

An image capturing system includes several image capturing units and a processing unit. A first image capturing unit of the image capturing units is configured to capture a first image having an object. The processing unit is configured to receive the first image and process the first image to generate a data signal, and transmit a command signal to a second image capturing unit of the capturing units according to the data signal. Furthermore, the second image capturing unit is configured to capture a second image having the object according to the command signal.

### RELATED APPLICATIONS

This application claims priority to Chinese Application Serial Number 201610644778.5, filed Aug. 9, 2016, which is herein incorporated by reference.

### BACKGROUND

### Field of Invention

The present disclosure relates to an imaging capturing device. More particularly, the present disclosure relates to an image capturing system and an image capturing method.

### Description of Related Art

With the rapid advance of image technology, the technique of capturing panoramic images becomes increasingly important and well-developed. Currently, capturing angles of an image capturing device for capturing panoramic images is adjusted manually, so as to track a target object panoramically and capture images of the target object. However, not only does the manner of capturing panoramic images manually waste manpower, but it is hard to ensure that the images of the target object can be captured continuously and instantaneously. For example, the front side image of the target object is captured in the first half of a panoramic image, and the front side image of the target object shall be captured in the last half of the panoramic image. However, owing to human errors, the side face image or the rear side image of the target object is captured in the last half of the panoramic image. Therefore, it is unable to keep the consistency of the images of the target object.

Accordingly, a significant challenge is related to ways in which to capture panoramic images perfectly while at the same time reducing the manpower associated with designing image capturing systems.

### SUMMARY

An aspect of the present disclosure is directed to an image capturing system. The image capturing system includes several image capturing units and a processing unit. A first image capturing unit of the image capturing units is configured to capture a first image having an object. The processing unit is configured to receive the first image and process the first image to generate a data signal, and transmit a command signal to a second image capturing unit of the capturing units according to the data signal. Furthermore, the second image capturing unit is configured to capture a second image having the object according to the command signal.

Another aspect of the present disclosure is directed to an image capturing method. The image capturing method includes operations as follows: capturing a first image having an object through a first image capturing unit; receiving and processing the first image through a processing unit to generate a data signal; transmitting a command signal to a second image capturing unit through the processing unit according to the data signal; and capturing a second image having the object through the second image capturing unit according to the command signal.

It is to be understood that the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block schematic diagram of an image capturing system according to some embodiments of the present disclosure; and

FIG. 2 is a flow chart of an image capturing method according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

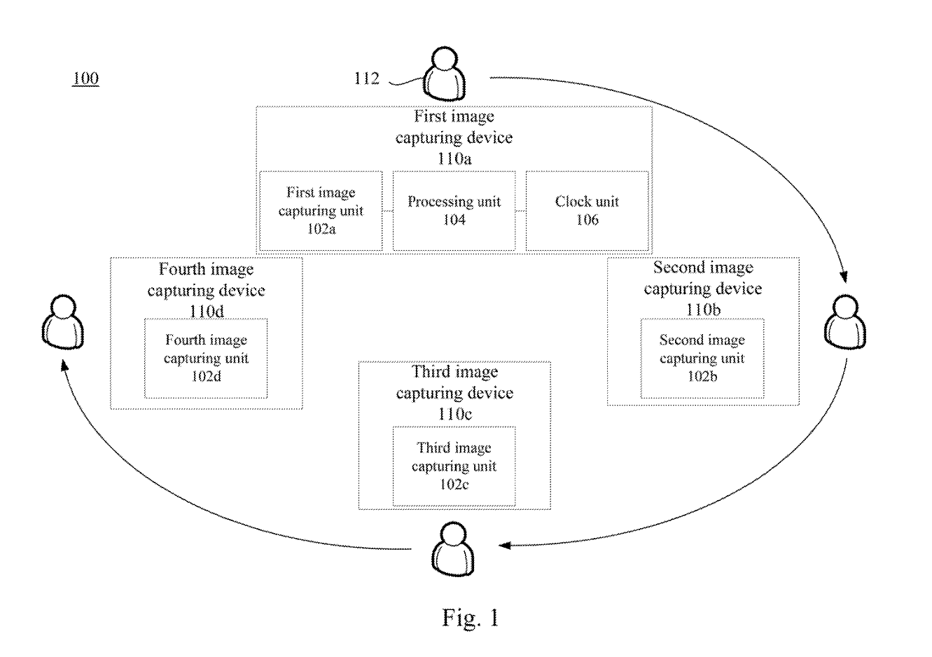

FIG. 1 is a block schematic diagram of an image capturing system 100 according to some embodiments of the present disclosure. As shown in FIG. 1, the image capturing system 100 includes several image capturing units (namely, a first image capturing unit 102a, a second image capturing unit 102b, a third image capturing unit 102c and a fourth image capturing unit 102d) and a processing unit 104. For example, the first image capturing unit 102a, the second image capturing unit 102b, the third image capturing unit 102c and the fourth image capturing unit 102d are connected to each other through a wired or a wireless manner.

Several image capturing units (namely, the first image capturing unit 102a, the second image capturing unit 102b, the third image capturing unit 102c and the fourth image capturing unit 102d) are configured to cooperate with each other to continuously capture images having an object 112, and the detailed explanation is given as follows. For example, the first image capturing unit 102a of the image capturing units is configured to capture a first image having the object 112, and the second image capturing unit 102b of the image capturing units is configured to capture a second image having the object 112. Furthermore, differences between the first image and the second image are associated with the motion condition of the object 112. The functions of the third image capturing unit 102c and the fourth image capturing unit 102d are similar to the first image capturing unit 102a and the second image capturing unit 102b, and so will not be repeated.

The processing unit 104 is configured to receive the images having the object 112 and process such images to generate a data signal, and transmit a command signal to the corresponding image capturing unit according to the data signal. For example, after the processing unit 104 receives the first image captured by the first image capturing unit 102a and generates the data signal according to the first image, the processing unit 104 transmits the command signal to the second image capturing unit 102b according to the data signal, so that the second image capturing unit 102b can capture the second image having the object 112 according to the command signal.

In one embodiment, the processing unit 104 calculates a motion condition of the object 112 according to the data signal, and transmits the command signal to the corresponding image capturing unit according to the motion condition of the object 112. For example, the motion condition of the object 112 can be the motion direction of the object 112, the motion velocity of the object 112 or the distance between the object 112 and a relative object. As shown in FIG. 1, after the processing unit 104 receives the first image captured by the first image capturing unit 102a and generates the data signal according to the first image, the processing unit 104 calculates the motion condition of the object 112 according to the data signal, such that it is determined that the object 112 moves from the first image capturing unit 102a to the second image capturing unit 102b. Therefore, the processing unit 104 selects out the second image capturing unit 102b to continuously capture images for the object 112. Subsequently, the processing unit 104 transmits the command signal to the second image capturing unit 102b. Furthermore, when the object 112 moves from the second image capturing unit 102b to the third image capturing unit 102c and the fourth image capturing unit 102d sequentially, the processing unit 104 executes the operations mentioned above repeatedly to make the third image capturing unit 102c and the fourth image capturing unit 102d capture a third image and a fourth image having the object 112 sequentially according to the command signal, but the present disclosure is not limited hereto. When the processing unit 104 determines that the object 112 moves from first image capturing unit 102a to the third image capturing unit 102c or the fourth image capturing unit 102d according to the motion condition of the object 112, the processing unit 104 selects out the third image capturing unit 102c or the fourth image capturing unit 102d to continuously capture images for the object 112. Additionally, the present disclosure is not limited to the motion direction represented by arrows as shown in FIG. 1. Specifically, the object 112 may moves arbitrarily, however, the image capturing system 100 in the present disclosure determines that the object 112 moves from the first image capturing unit 102a to which image capturing unit (namely, one of the second image capturing unit 102b, the third image capturing unit 102c and the fourth image capturing unit 102d) according to the motion condition of the object 112, and then the processing unit 104 selects out such image capturing unit to continuously capture images for the object 112. The operations mentioned above are executed repeatedly to accurately track the object 112 for image capturing.

In one embodiment, one of the image capturing units (such as the first image capturing unit 102a) and the processing unit 104 can be integrated into an image capturing device (such as a first image capturing device 110a). For example, when the processing unit 104 and the first image capturing unit 102a of the image capturing units are integrated into the first image capturing device 110a, the first image captured by the first image capturing unit 102a in the first image capturing device 110a can be processed through the processing unit 104 directly to generate the data signal. In another embodiment, since the processing unit 104 can be integrated with only one of the image capturing units into the image capturing device, the image capturing device having the processing unit 104 is therefore configured to process the images having the object 112 which are captured by all of the image capturing units so as to generate the data signal, and transmit the command signal to the corresponding image capturing unit according to the data signal. In further embodiment, the processing unit 104 can also be integrated with the second image capturing unit 102b, the third image capturing unit 102c or the fourth image capturing unit 102d into the image capturing device, or the image capturing system 100 includes several processing units 104, and such processing units 104 are respectively integrated with the image capturing units into several image capturing devices (namely, the first image capturing device 110a, the second image capturing device 110b, the third image capturing device 110c and the fourth image capturing device 110d). Therefore, the image capturing device having the processing unit 104 is used to be a control center to process the images having the object 112 which are captured by all of the image capturing devices, so as to transmit the command signal to the corresponding image capturing device for controlling thereby the image capturing device tracking the object 112 continuously.

In one embodiment, the image capturing unit (such as the first image capturing unit 102a) and a clock unit 106 can be integrated into the image capturing device (such as the first image capturing device 110a), and the clock unit 106 is configured to mark a timestamp on the images having the object 112 which are captured by the image capturing units in the image capturing device. For example, after the first image capturing unit 102a in the first image capturing device 110a captures the first image having the object 112, the first image capturing device 110a marks the timestamp on the first image having the object 112 through the clock unit 106. In other words, the clock unit 106 can also be integrated with the second image capturing unit 102b, the third image capturing unit 102c or the fourth image capturing unit 102d into the image capturing device. For example, the image capturing system 100 includes several clock units 106, and such clock units 106 are respectively integrated with the image capturing units into several image capturing devices, (namely, the first image capturing device 110a, the second image capturing device 110b, the third image capturing device 110c and the fourth image capturing device 110d). After the image capturing unit in the image capturing device captures the images having object 112, the image capturing device marks the timestamp on the images having object 112 through the clock unit 106.

In another embodiment, the image capturing device calculates a length of time that the object 112 appears in the captured image according to the timestamp. For example, the first image capturing device 110a calculates the length of time that the object 112 appears in the first image according to the timestamp, so as to quickly search the location of the object 112 in the first image according to the timestamp and the length of time that the object 112 appears in the first image. Furthermore, the operations mentioned above are also convenient to execute subsequent edition for the first image.

In one embodiment, when several objects 112 exist, a user selects out the object 112 which is being tracked to make the image capturing system 100 continuously capture images for the selected object 112 through the image capturing units which cooperate with each other, or the image capturing system 100 selects out some of the object 112 according to the size of the object 112, the voice of the object 112, the shape of the object 112 or the focusing range of the object 112 to continuously track and capture images for the selected objects 112 through the image capturing units which cooperate with each other.

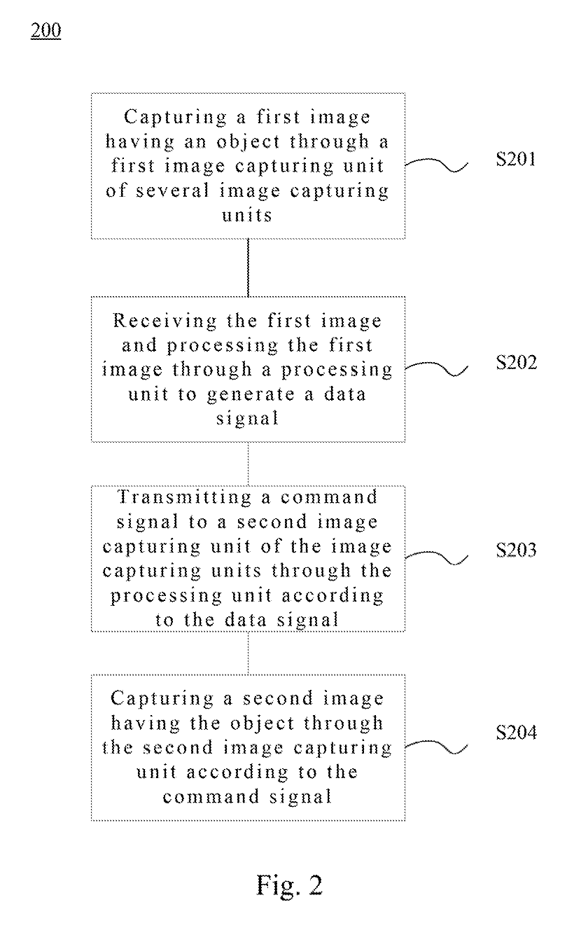

FIG. 2 is a flow chart of an image capturing method 200 according to some embodiments of the present disclosure. In one embodiment, the image capturing method 200 can be implemented by the image capturing system 100, but the present disclosure in not limited hereto. For facilitating the understanding of the image capturing method 200, the image capturing system 100 is used to be an example so as to implement the image capturing method 200 as follows. As shown in FIG. 2, firstly in the operation S201, capturing the first image having the object 112 is executed through the first image capturing unit 102a of the image capturing units. In the operation S202, receiving the first image and processing the first image are executed through the processing unit 104 to generate the data signal. In the operation S203, transmitting the command signal to the second image capturing unit 102b of the image capturing units is executed through the processing unit 104 according to the data signal. Finally, in the operation S204, capturing the second image of the object 112 is executed through the second image capturing unit 102b according to the command signal.

In one embodiment, referring to the operation S203, after receiving the first image and processing the first image are executed through the processing unit 104 to generate the data signal, the motion condition of the object 112 is calculated through the processing unit 104 according to the data signal, and the command signal is transmitted to the corresponding second image capturing unit 102b according to the motion condition of the object 112. For example, the motion condition of the object 112 can be the motion direction of the object 112, the motion velocity of the object 112 or the distance between the object 112 and a relative object. After the motion condition of the object 112 is calculated through the processing unit 104 according to the data signal, it is determined that the object 112 moves from the first image capturing unit 102a to the second image capturing unit 102b through the processing unit 104. Accordingly, the second image capturing unit 102b is selected out to continuously capture images for the object 112 through the processing unit 104. Subsequently, the command signal is transmitted to the second image capturing unit 102b through the processing unit 104. Furthermore, when the object 112 continuously moves from the second image capturing unit 102b to other image capturing units (such as the third image capturing unit 102c or the fourth image capturing unit 102d), the operations mentioned above are executed repeatedly to make the other image capturing units capture the images having the object 112 sequentially according to the command signal through the processing unit 104.

In one embodiment, referring to the operation S201, after capturing the first image having the object 112 is executed through the first image capturing unit 102a of the image capturing units, the timestamp is marked on the first image having the object 112 through the clock unit 106. In another embodiment, after the timestamp is marked on the first image having the object 112 through the clock unit 106, the length of time that the object 112 appears in the first image is calculated according to the timestamp. For example, the length of time that the object 112 appears in the first image is calculated through the first image capturing device 110a according to the timestamp, so as to quickly search the location of the object 112 in the first image according to the timestamp and the length of time that the object 112 appears in the first image. Furthermore, the operations mentioned above are also convenient to execute subsequent edition for the first image.

In further embodiment, after the length of time that object 112 appears in the first image is calculated according to the timestamp, the object 112 in the first image is searched through editing software according to the length of time, so as to edit the first image having the object 112. For example, after the first image and the second image having the object 112 are captured through the first image capturing unit 102a and the second image capturing unit 102b respectively, the location of the object 112 in the first image and in the second image are searched through the editing software according to the length of time in advance, and then the first image and the second image are edited according to the location of the object 112 in the first image and in the second image, so as to make the object 112 continuously appear in the center of the first image and the second image. In other words, the effect that the object 112 continuously appears in the center of the first image and the second image can be achieved by deleting some parts of the first image and the second image (such as images that the object 112 appears on the edge of the first image and in the second image) and combining the rest parts of the first image with the second image.

As mentioned above, the image capturing system and the image capturing method in the present disclosure analyze the images of the object which are captured by the different image capturing units to generate the data signal through the processing unit, and transmit the command signal according to data signal so as to establish the cooperation among the image capturing units. Therefore, the object can be tracked and the images of the object can be captured continuously and instantaneously. Furthermore, the image capturing system and the image capturing method in the present disclosure mark the timestamp on the images of the object. Accordingly, the image capturing system and the image capturing method are able to not only support the function for quickly searching the object in the images, but also edit the images of the object through the editing software to make the object continuously appear n the center of the images.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present invention cover modifications and variations of this present disclosure provided they fall within the scope of the following claims.

What is claimed is:

1. An image capturing system, comprising:
a plurality of image capturing units, wherein a first image capturing unit of the image capturing units is configured to capture a first image having an object; and
a processing unit, configured to receive the first image and process the first image to generate a data signal, and transmit a command signal to a second image capturing unit of the capturing units in accordance with the data signal,
wherein the second image capturing unit is configured to capture a second image having the object in accordance with the command signal.

2. The image capturing system of claim 1, wherein the processing unit calculates a motion condition of the object in accordance with the data signal, and transmits the command signal to the second image capturing unit in accordance with the motion condition of the object.

3. The image capturing system of claim 1, wherein the first image capturing unit and the processing unit are integrated into an image capturing device, and the image capturing device processes the first image through the processing unit to generate the data signal.

4. The image capturing system of claim 1, wherein the first image capturing unit and a clock unit are integrated into an image capturing device, and the clock unit is configured to mark a timestamp on the first image having the object.

5. The image capturing system of claim 4, wherein the image capturing device calculates a length of time that the object appears in the first image in accordance with the timestamp.

6. An image capturing method, comprising:
capturing a first image having an object through a first image capturing unit;
receiving and processing the first image through a processing unit to generate a data signal;
transmitting a command signal to a second image capturing unit through the processing unit in accordance with the data signal; and
capturing a second image having the object through the second image capturing unit in accordance with the command signal.

7. The image capturing method of claim 6, wherein transmitting the command signal to the second image capturing unit through the processing unit in accordance with the data signal comprises:
calculating a motion condition of the object through the processing unit in accordance with the data signal, and transmitting the command signal to the second image capturing unit in accordance with the motion condition of the object.

8. The image capturing method of claim 6, further comprising:
marking a timestamp on the first image having the object through a clock unit.

9. The image capturing method of claim 8, further comprising:
calculating a length of time that the object appears in the first image in accordance with the timestamp.

10. The image capturing method of claim 9, further comprising:
searching the object in the first image in accordance with the length of time, so as to edit the first image having the object.
